(19) United States
(12) Patent Application Publication
(10) Pub. No.: US 2017/0103129 A1
(43) Pub. Date: Apr. 13, 2017

(54) SCORING CONTENT WITHIN NATIVE APPLICATIONS

(71) Applicant: GOOGLE INC., Mountain View, CA (US)

(72) Inventors: Dong Ha Lee, Palo Alto, CA (US); Jaehyun Yeom, Mountain View, CA (US)

(73) Assignee: GOOGLE INC., Mountain View, CA (US)

(21) Appl. No.: 14/880,947

(22) Filed: Oct. 12, 2015

(51) Int. Cl. G06F 17/30

(52) U.S. Cl. CPC G06F 17/30867; G06F 17/3053; G06F 17/30528; G06F 17/30554

(57) ABSTRACT

Methods, systems, and apparatus, including computer programs encoded on computer storage media, for receiving relevance scores for a respective set of web resources, each relevance score indicative of a relevance of a web resource to which it corresponds to a search query; for each web resource, obtaining a plurality of similarity scores, each similarity score for the web resource representing a similarity between the web resource and respective content referenced by a respective deeplink to a native application; generating a respective quality score for the content referenced by the deeplink based on the respective relevance scores for the web resources and the respective similarity scores between the web resources and the content referenced by the deeplink; selecting deeplinks referencing content having a respective quality score that satisfies a threshold quality score; and providing the selected deeplinks with a plurality of web search results that each reference a corresponding web resource.

### BACKGROUND

The Internet provides access to a wide variety of information. For example, digital image files, video and/or audio files, as well as web page resources for particular subjects or particular news articles, are accessible over the Internet. With respect to web page resources, many of these resources are designed to facilitate the performing of particular functions, such as banking, booking hotel reservations, shopping, etc., or to provide structured information, such as on-line encyclopedias, movie databases, etc. Search engines crawl and index these resources to facilitate searching of the resources.

Furthermore, with the advent of tablet computers and smart phones, native applications that facilitate the performance of the same functions facilitated by the use of web page resources are now being provided in large numbers. Additionally, native applications that do not have corresponding websites with similar content, such as games, are also very popular on tablet computers and smart phones. Accordingly, search engines now also facilitate searching of these native applications.

One process by which search engines gather information for native applications is by accessing “deeplinks” for native applications. A deeplink is an instruction specifying a particular environment instance of a native application and configured to cause the native application to instantiate the environment instance of the specified native application when selected at a user device. The native application generates the environment instance for display within the native application on a user device. For example, a deeplink may be a URI that specifies a particular native application, resource content that the native application is to access, and a particular user interface that should be instantiated when the native application is launched by use of the deeplink. For example, a deeplink may specify a selection menu for a game environment; or a particular selection of a song for a music application; or a particular recipe for a cooking application; and the like.

Search engines now also facilitate searching of these native applications. A user's informational need may thus be satisfied by search engines providing search results that identify either one (or both) of a particular web page resource that describes a native application, and search results for the native application itself.

### SUMMARY

In general, this specification describes a system for scoring content within native applications.

In general, one innovative aspect of the subject matter described in this specification can be embodied in methods that include the actions of receiving relevance scores for a respective set of web resources, each relevance score indicative of a relevance of a web resource to which it corresponds to a search query; for each web resource of the plurality of web resources, obtaining a plurality of similarity scores, each similarity score for the web resource representing a similarity between the web resource and respective content referenced by a respective deeplink to a native application; generating, for each of the deeplinks, a respective quality score for the content referenced by the deeplink based on the respective relevance scores for the web resources and the respective similarity scores between the web resources and the content referenced by the deeplink; selecting deeplinks referencing content having a respective quality score that satisfies a threshold quality score; and providing, to a user device in response to the search query, the selected deeplinks with a plurality of web search results that each reference a corresponding web resource.

Implementations can include one or more of the following features. Prior to obtaining the plurality of similarity scores: generating, for each web resource, the plurality of similarity scores for the web resource from the content and the web resource. Generating the plurality of similarity scores is based on one or more of the following: n-gram Jaccard similarity, minimum hash, or locality-sensitive hashing for the plurality of similarity scores. Generating, for each of the deeplinks, the respective quality score for the content referenced by the deeplink comprises: computing, for each web resource, a respective product of the respective relevance score for the web resource and the respective similarity score between the web resource and the content referenced by the deeplink; and summing each product to generate the respective quality score. Each deeplink to a respective native application specifies a particular environment instance of the respective native application and, when selected at the user device, causes the respective native application to instantiate an instance of the respective native application in which content referenced in the deeplink is displayed. Each relevance score for a respective web resource is based on a ranking of the respective web resource in a list of web resources ranked by a search engine. Selecting deeplinks referencing content having respective quality scores that satisfy a threshold quality score comprises selecting a maximum number of deeplinks referencing content having quality scores that satisfy the threshold quality score. Providing, to the user device, the plurality of deeplinks with the plurality of web search results comprises: normalizing, for each deeplink, the respective quality score for the deeplink to the respective relevance scores for the web search results to generate a normalized relevance score for the deeplink; ranking the web search results and deeplinks based on the relevance scores and the normalized relevance scores to generate a ranked list of web search results and deeplinks; and providing the ranked list of web search results and deeplinks to the user device. The respective content referenced by the respective deeplink is not a web resource.

Particular embodiments of the subject matter described in this specification can be implemented so as to realize one or more of the following advantages. Some native applications do not have corresponding web pages for the native applications. The system can rank these native applications without corresponding web and/or content pages despite not having relevance scores of already existing corresponding web pages to use as a base metric.

Search results that include a link to a particular location within a native application, with or without corresponding web pages (e.g., a mobile app), can be ranked with other search results (e.g., search results to web pages) such that the more relevant resources (app or web page) are ranked higher. This inclusion of search results that link to locations within applications provide additional search result options that may better satisfy users' informational needs.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which triggering the search of and the ranking of native applications occurs.

FIG. 2A is a flow diagram of an example method for generating similarity scores between content within native applications and web resources

FIG. 2B is a flow diagram of an example method for scoring content within native applications.

FIG. 3 is an illustration of scoring content within native applications.

FIG. 4 is an illustration of native application search results provided with web search results.

Like reference numbers and designations in the various drawings indicate like elements.

### DETAILED DESCRIPTION

A system scores content within native applications that do not have corresponding web pages. That is, the native applications can display content that is not accessible at a web resource (e.g., a web page) through a web browser. The content within the native applications can be scored based on web resources similar to the content, which will be described further below.

As used herein, a native application generates environment instances for display on a user device within an environment of the native application, and operates independent of a browser application on the user device. A native application is an application specifically designed to run on a particular user device operating system and machine firmware. Native applications thus differ from browser-based applications and browser-rendered resources. The latter require all, or at least some, elements or instructions downloaded from a web server each time they are instantiated or rendered. Furthermore, browser-based applications and browser-rendered resources can be processed by all web-capable mobile devices within the browser and thus are not operating system specific.

If a search is triggered to include native application search results with web search results, a native application index is searched for native applications and the native applications are scored. A variety of scoring signals can be used, including indexed content of native applications, user ratings of the native applications, the query popularity for queries received for searches of the application index, etc. Native applications, once scored in response to the query, are ranked as set forth below, and one or more native application search results may be provided to the user device in response to the query.

Whether a native application search result is provided, and if provided, the position of the native application search result relative to other search results, is determined based on filtering criteria and ranking criteria. The filtering criteria and ranking criteria may include the ranking of a corresponding resource that describes the native application relative to other resources, the scores of the native applications, and other factors.

These features and other features are described in more detail below.

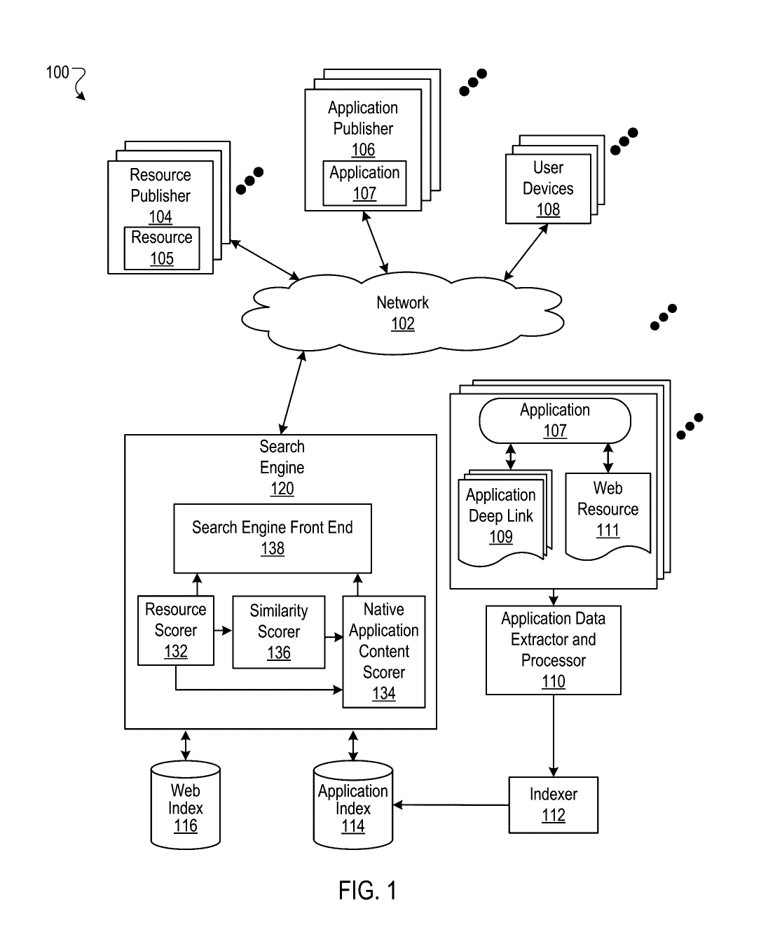

FIG. 1 is a block diagram of an example environment 100 in which triggering the search of and the ranking of native applications occurs. A computer network 102, such as the Internet, connects resource publisher websites 104, application publishers 106, user devices 108 and a search engine 120.

A resource publisher website 104 includes one or more web resources 105 associated with a domain and hosted by one or more servers in one or more locations. Generally, a resource publisher website is a collection of web pages formatted in hypertext markup language (HTML) that can contain text, images, multimedia content, and programming elements. Each website 104 is maintained by a content publisher, which is an entity that controls, manages and/or owns the website 104.

A web page resource is any data that can be provided by a publisher website 104 over the network 102 and that has a resource address, e.g., a uniform resource locator (URL). Web resources may be HTML pages, images files, video files, audio files, and feed sources, to name just a few. The resources may include embedded information, e.g., meta information and hyperlinks, and/or embedded instructions, e.g., client-side scripts. More generally, a “resource” is anything identifiable over a network, and can also include native applications.

An application publisher website 106 may also include one or more web resources 105, and also provides native applications 107. As described above, a native application 107 is an application specifically designed to run on a particular user device operating system and machine firmware. Native applications 107 may include multiple versions designed to run on different platforms. For example, native applications corresponding to a movie database website may include a first native application that runs on a first type of smart phone, a second native application that runs on a second type of smart phone, a third native application that runs on a first type of tablet, etc.

As used in this specification, an “environment instance” is a display environment within a native application and in which is displayed content, such as text, images, and the like. An environment instance is specific to the particular native application, and the native application is specific to the particular operating system of the user device 108. An environment instance differs from a rendered web resource in that the environment instance is generated within and specific to the native application, while a web resource may be rendered in any browser for which the web page resource is compatible, and is independent of the operating system of the user device.

A user device 108 is an electronic device that is under the control of a user. A user device 108 is typically capable of requesting and receiving web page resources 104 and native applications 107 over the network 102. Example user devices 108 include personal computers, mobile communication devices, and tablet computers.

To search web resources 105 and the native applications 107, the search engine 120 accesses a web index 116 and an application index 114. The web index 116 is an index of web resources 105 that has, for example, been built from crawling the publisher websites 104. The application index 114 is an index of application pages for native applications 107, and is constructed using an application data extractor and processor 110 and an indexer 112. Although shown as separate indexes, the web index 116 and the application index 114 can be combined in a single index.

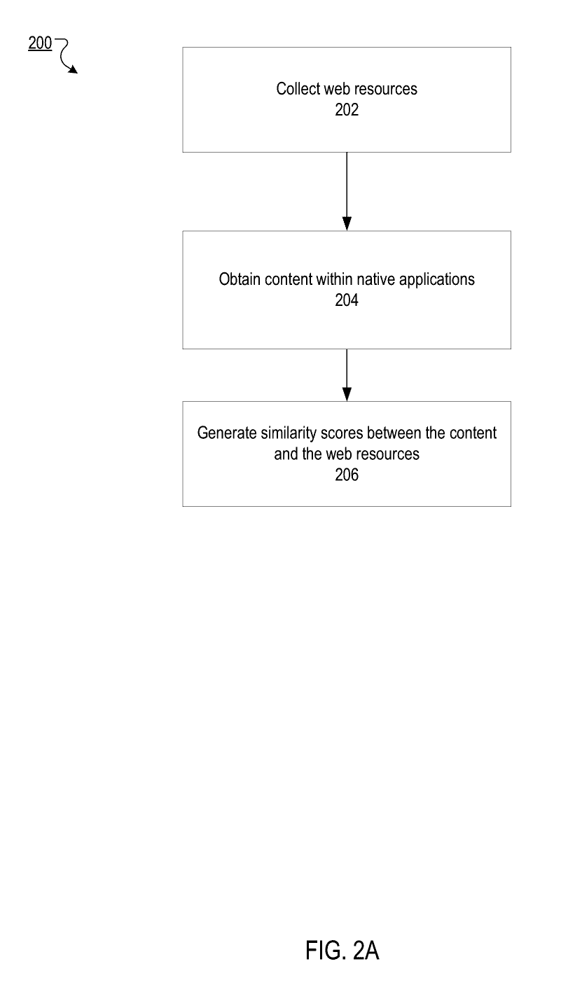

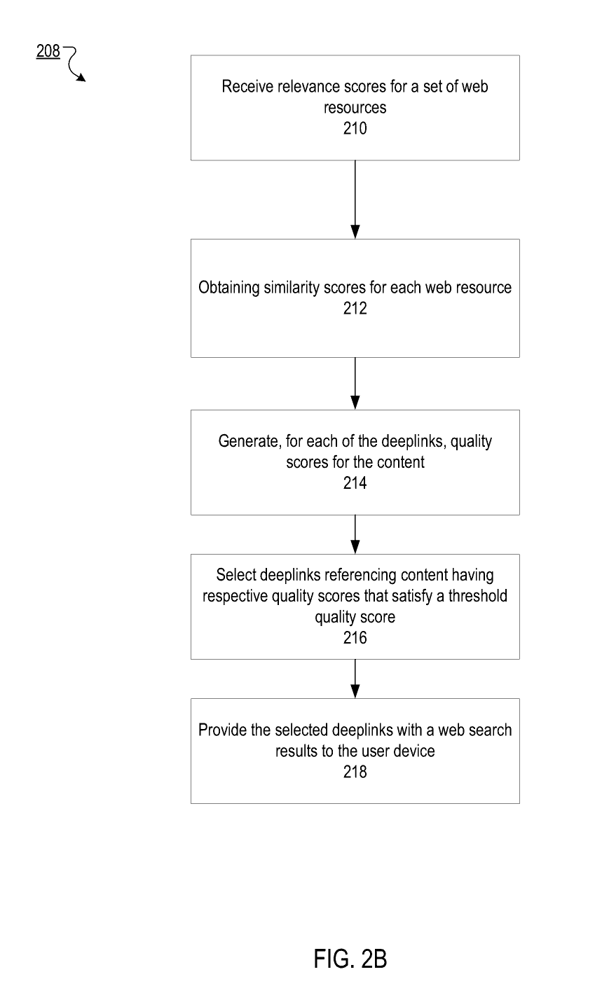

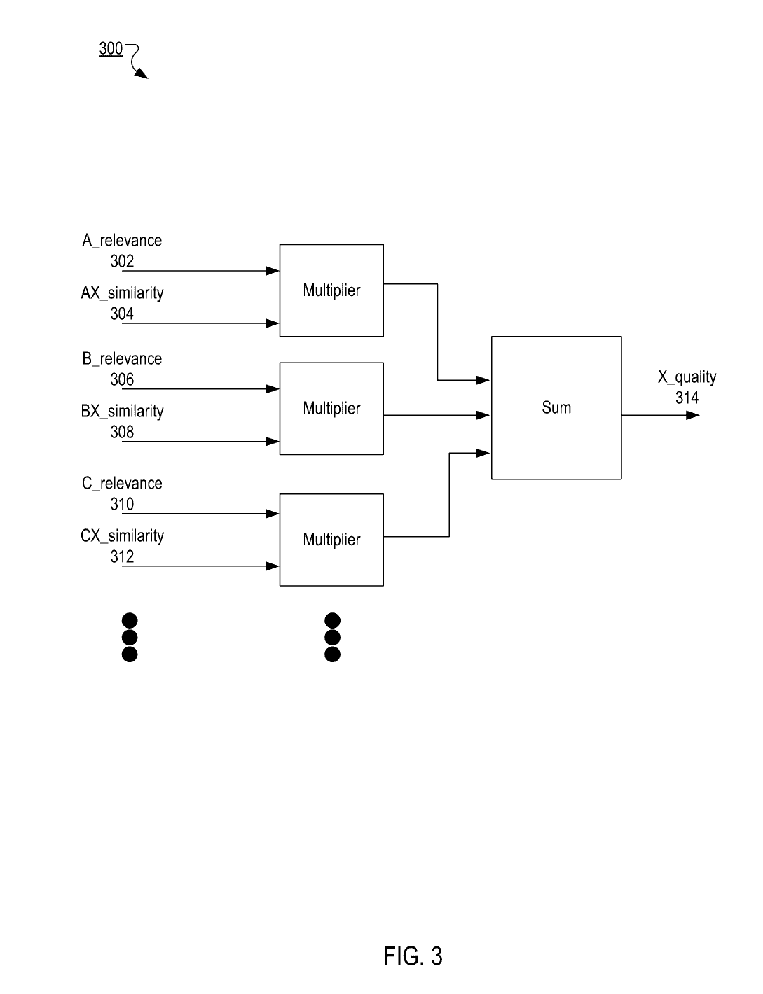

The user devices 108 submit search queries to the search engine 120. In response to each query, the search engine 120 accesses the web index 116 and, optionally, the application index 114 to identify resources and applications, respectively, that are relevant to the query. Generally, a first type of search operation implementing a first search algorithm is used to search the index 116, and a second type of search operation implementing a second, different algorithm is used to search the application index 114. The search engine 120 implements a resource scorer 132 process to generate relevance scores for web resources, and a similarity scorer 136 process to generate similarity scores between web resources and content within native applications. The content within native applications is not a web resource. A native application content scorer 134 process generates a quality score for the content within native applications based on the relevance and similarity scores. The native application content scorer 134 will be described further below with reference to FIGS. 2 and 3. A variety of appropriate search engine algorithms can be used to implement the resource scorer 132, the similarity scorer 136, and the native application content scorer 134.

The search engine 120 utilizes a search engine front end 138, such as a web server, to determine whether to search the native application index 114 and provide a native application search result to a user device. The search engine front end 138 arranges and provides the search results to the user device 108 from which the query was received.

A web resource search result is data generated by the search engine 120 that identifies a web resource and provides information that satisfies a particular search query. A web resource search result for a resource can include a web page title, a snippet of text extracted from the resource, and a resource locator for the resource, e.g., the URL of a web page. A native application search result specifies a native application and is generated in response to a search of the application index 114. A native application search result may include a “deep link” specifying a particular environment instance of the native application and which is configured to cause the native application to instantiate the specified environmental instance. For example, selection of a native application search result may cause the native application to launch (if installed on the user device 108) and generate an environment instance referenced in the application search result in the form of a screen shot. Alternatively, a native application search result may include a “purchase” (or “install”) command that, when selected, results in a purchase (or free download) and installation of the native application on a user device.

Publishers 106 that provide native applications 107 also provide the deep links 109 to the search engine 120. For example, an application publisher may provide a list of deep links 109 in the form of uniform resource identifiers (URIs) (or other instruction types that are specific to the native application published by the publisher). These deep links are deep links that publisher 106 desires to be crawled and indexed in the application index 114.

For many native applications 107, there also exist web resources 111 that are descriptive of the native applications 107. One example of such a resource 111 is a product page in an on-line native application store. The product page can be browsed using a web browser, and can be indexed in the web index 116. The web resource 111 may include screen shots of the native application, descriptions of user ratings, and the like. Typically the web resource 111 is a web page specific to the native application, and is used to facilitate a purchase and/or download of the native application.

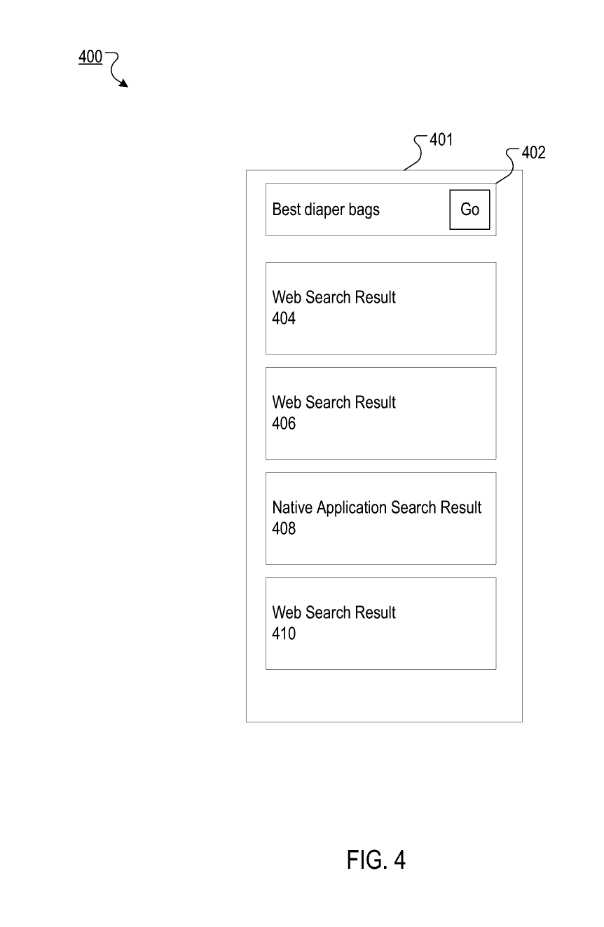

In certain situations, depending on the search query and the corresponding web based search result, the search engine 120 may include in a set of web page search results a native application search result. The native application search result may be, for example, inserted at a position relative to a product web page search result for the native application, or, alternatively, may entirely replace the product web page search result. This is further described with reference to FIG. 4 below.

FIG. 2A is a flow diagram 200 of an example method for generating similarity scores between content within native applications and web resources. For convenience, the method 200 will be described with respect to a system, e.g., the search engine 120 of FIG. 1, having one or more computing devices that execute software to implement the method 200.

The system collects web resources (step 202). The web resources can be collected from a web index, e.g., the web index 116 of FIG. 1.

The system obtains content within native applications (step 204). In some implementations, the content is content from application pages of the native application indexed within an application index, e.g., content from an application index 114 of FIG. 1.

The system generates similarity scores between the content and the web resources (step 206). The similarity scores between the web resource and the respective content using conventional methods. For example, the system can generate the similarity score based on n-gram Jaccard similarity, minimum hash, or locality-sensitive hashing.

In some implementations, the system generates an output in the form of
[wd_1, [(nac_1, s_11), (nac_2, s_12), (nac_3, s_13) . . . ],
wd_2, [(nac_1, s_21), (nac_2, s_22), (nac_3, s_23) . . . ], . . . ]

Where wd_i (e.g., wd_1 or wd_2) is a web document i, nac_j (e.g., nac_1) is native application content j, s_ij (e.g., s_11) is a similarity score between the web document i and the native application content j. Also, s_ij=similarity (wd_i, nac_j)=similarity (nac_j, wd_i); similarity is a function that computes the similarity score s_ij.

The system uses the output to generate quality scores for the content within the native application, which will be described further below with reference to FIG. 2A.

FIG. 2B is a flow diagram 208 of an example method for scoring content within native applications. For convenience, the method 208 will be described with respect to a system, e.g., the search engine 120 of FIG. 1, having one or more computing devices that execute software to implement the method 208.

The system receives relevance scores for a set of web resources (step 210). Each web resource has a relevance score that indicates a relevance of the web resource to a search query.

In some implementations, the relevance score is based on a ranking of the web resource in a list of web resources ranked by a search engine. For example, the relevance score can be computed using Equation 1 below

$$Relevance Score = \frac{s - r}{s} \qquad ( 1 )$$

Where s is a number of search results in a list of search results responsive to the search query and r is a rank of the web resource in the list of search results.

The system obtains, for each web resource in the set of web resources, a set of similarity scores for the web resource (step 212). The similarity scores can be obtained from an output vector, as described above with reference to FIG. 2A. Each similarity score for the web resource can represent a similarity between the web resource and respective content within native applications that do not have corresponding web or content pages.

The respective content can be referenced by a respective deeplink to a native application. The respective deeplink specifies a particular environment instance of the native application and, when selected at the user device, causes the native application to instantiate an instance of the respective native application in which the respective content referenced in the deeplink is displayed.

The system generates, for each of the deeplinks, a respective quality score for the content referenced by the deeplink (step 214). The quality score for the content referenced by the deeplink can be generated from similarity scores between the content and web resources and relevance scores of the web resources. This will be described further below with reference to FIG. 3.

The system selects deeplinks referencing content having a respective quality score that satisfies a threshold quality score (step 216). In some implementations, the system selects a maximum number of deeplinks having quality scores that satisfy the threshold quality score. The maximum number can be determined by an administrator of the system.

The system provides the selected deeplinks with web search results that each reference a corresponding web resource (step 218). The system can provide the selected deeplinks and web search results to a user device in response to the search query.

In some implementations, the system normalizes, for each deeplink, the respective quality score for the deeplink to the respective relevance scores for the web search results to generate a normalized relevance score for the deeplink. For example, if a particular relevance score can be a number in a range of numbers, the system can scale, e.g., with a scaling coefficient, the quality score for the deeplink to a proportional number within the range of numbers for the relevance score.

The system can rank the web search results and deeplinks based on the relevance scores and the normalized relevance scores to generate a unified ranked list of web search results and deeplinks. Then, the system can provide the ranked list of web search results and deeplinks to the user device, which will be described further below with reference to FIG. 4.

In some implementations, steps 210-218 are performed in response to a search query from a user. In some other implementations, generating the similarity scores can be performed is performed as part of a backend process.

FIG. 3 is an illustration 300 of scoring content within native applications using a native application content scorer of a search engine given a search query. The content can be an application page X that has no corresponding web pages from a web index, e.g., the web index 116 from FIG. 1. The native application content scorer can generate a quality score, X_quality 314, for the application page X.

To generate the quality score X_quality 314, the scorer can compute a dot product between a vector of relevance scores for a set of web resources and a vector of similarity scores for the set of web resources. In other words, the quality score can be computed using Equation 2 below:

Quality Score (x)=Σₖ₌₁ⁿrelevance(resourceₖ)*similarity (resourceₖ,x) (2)

Where x is an application page without a corresponding web page, resourceₖ is a kth web resource in the set of n web resources, the relevance function returns a relevance score, and the similarity function returns a similarity score indicating the similarity between a kth web resource and application page x.

By way of illustration, A, B, and C can be web resources, e.g., from web index 116 of FIG. 1. Therefore, A_relevance 302 is a relevance score for A to the search query, AX_similarity 304 is a similarity score indicating how similar web resource A is to application page X, B_relevance 306 is a relevance score for B to the search query, BX_similarity 308 is a similarity score indicating how similar web resource B is to application X, C_relevance 310 is a relevance score for C to the search query, CX_similarity 312 is a similarity score indicating how similar web resource C is to application X, and so on. The scorer can compute a product of A_relevance 302 and AX_similarity 304, a product of B_relevance 306 and BX_similarity 308, a product of C_relevance 310 and CX_similarity 312, and so on, and then sum up the products to generate the X_quality score 314.

The scorer can compute a dot product in this way for each application page in the application index that does not have corresponding web and/or content pages to score the application page.

FIG. 4 is an illustration of native application search results provided with web search results. The search results can be provided at a browser application of a user device.

The browser application displays a view 401 of search results 404-410 provided in response to a search query 402 by a search engine. One of the search results is a native application search result, i.e., native application search result 408, while the remaining search results are web search results, i.e., web search results 404, 406, 410. Search results 404-410 are displayed in an order of decreasing relevance scores for the web search results 404, 406, 410 the native application search result 408.

The native application search result 408 is a deeplink that, when selected, can cause a native application to instantiate an instance of the respective native application in which content referenced in the native application search result 408 is displayed on the user device.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory computer storage medium for execution by, or to control the operation of, data processing apparatus. The computer storage medium can be a machine-readable storage device, a machine-readable storage substrate, a random or serial access memory device, or a combination of one or more of them. The computer program may include multiple files, and may be deployed to execute one or more data processing apparatus.

The term “data processing apparatus” encompasses all kinds of apparatus, devices, and machines for processing data, including by way of example a programmable processor, a computer, special-purpose circuitry, or multiple processors or computers. The apparatus can also include, in addition to hardware, code that creates an execution environment for the computer program in question, e.g., code that constitutes processor firmware, a protocol stack, a database management system, an operating system, or a combination of one or more of them.

The processes and logic flows described in this specification can be performed by one or more programmable computers executing one or more computer programs to perform functions by operating on input data and generating output, or one or more special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, comprising:
receiving relevance scores for a respective set of web resources, each relevance score indicative of a relevance of a web resource to which it corresponds to a search query;
for each web resource of the plurality of web resources, obtaining a plurality of similarity scores, each similarity score for the web resource representing a similarity between the web resource and respective content referenced by a respective deeplink to a native application;
generating, for each of the deeplinks, a respective quality score for the content referenced by the deeplink based on the respective relevance scores for the web resources and the respective similarity scores between the web resources and the content referenced by the deeplink;
selecting deeplinks referencing content having a respective quality score that satisfies a threshold quality score; and
providing, to a user device in response to the search query, the selected deeplinks with a plurality of web search results that each reference a corresponding web resource.

2. The method of claim 1, wherein prior to obtaining the plurality of similarity scores:
generating, for each web resource, the plurality of similarity scores for the web resource from the content and the web resource.

3. The method of claim 2, wherein generating the plurality of similarity scores is based on one or more of the following: n-gram Jaccard similarity, minimum hash, or locality-sensitive hashing for the plurality of similarity scores.

4. The method of claim 1, wherein generating, for each of the deeplinks, the respective quality score for the content referenced by the deeplink comprises:
computing, for each web resource, a respective product of the respective relevance score for the web resource and the respective similarity score between the web resource and the content referenced by the deeplink; and
summing each product to generate the respective quality score.

5. The method of claim 1, wherein each deeplink to a respective native application specifies a particular environment instance of the respective native application and, when selected at the user device, causes the respective native application to instantiate an instance of the respective native application in which content referenced in the deeplink is displayed.

6. The method of claim 1, wherein each relevance score for a respective web resource is based on a ranking of the respective web resource in a list of web resources ranked by a search engine.

7. The method of claim 1, wherein selecting deeplinks referencing content having respective quality scores that satisfy a threshold quality score comprises selecting a maximum number of deeplinks referencing content having quality scores that satisfy the threshold quality score.

8. The method of claim 1, wherein providing, to the user device, the plurality of deeplinks with the plurality of web search results comprises:
normalizing, for each deeplink, the respective quality score for the deeplink to the respective relevance scores for the web search results to generate a normalized relevance score for the deeplink;
ranking the web search results and deeplinks based on the relevance scores and the normalized relevance scores to generate a ranked list of web search results and deeplinks; and
providing the ranked list of web search results and deeplinks to the user device.

9. The method of claim 1, wherein the respective content referenced by the respective deeplink is not a web resource.

10. A system comprising:
one or more computers; and
computer-readable medium coupled to the one or more computers and having instructions stored thereon, which, when executed by the one or more computers, cause the one or more computers to, for each of the neural network layers, perform operations comprising:
receiving relevance scores for a respective set of web resources, each relevance score indicative of a relevance of a web resource to which it corresponds to a search query;
for each web resource of the plurality of web resources, obtaining a plurality of similarity scores, each similarity score for the web resource representing a similarity between the web resource and respective content referenced by a respective deeplink to a native application;
generating, for each of the deeplinks, a respective quality score for the content referenced by the deeplink based on the respective relevance scores for the web resources and the respective similarity scores between the web resources and the content referenced by the deeplink;
selecting deeplinks referencing content having a respective quality score that satisfies a threshold quality score; and
providing, to a user device in response to the search query, the selected deeplinks with a plurality of web search results that each reference a corresponding web resource.

11. The system of claim 10, wherein prior to obtaining the plurality of similarity scores:
generating, for each web resource, the plurality of similarity scores for the web resource from the content and the web resource.

12. The system of claim 10, wherein generating, for each of the deeplinks, the respective quality score for the content referenced by the deeplink comprises:
computing, for each web resource, a respective product of the respective relevance score for the web resource and the respective similarity score between the web resource and the content referenced by the deeplink; and
summing each product to generate the respective quality score.

13. The system of claim 10, wherein providing, to the user device, the plurality of deeplinks with the plurality of web search results comprises:
normalizing, for each deeplink, the respective quality score for the deeplink to the respective relevance scores for the web search results to generate a normalized relevance score for the deeplink;
ranking the web search results and deeplinks based on the relevance scores and the normalized relevance scores to generate a ranked list of web search results and deeplinks; and
providing the ranked list of web search results and deeplinks to the user device.

14. The system of claim 10, wherein the respective content referenced by the respective deeplink is not a web resource.

15. A computer-readable medium having instructions stored thereon, which, when executed by one or more computers, cause the one or more computers to perform operations comprising:
receiving relevance scores for a respective set of web resources, each relevance score indicative of a relevance of a web resource to which it corresponds to a search query;
for each web resource of the plurality of web resources, obtaining a plurality of similarity scores, each similarity score for the web resource representing a similarity between the web resource and respective content referenced by a respective deeplink to a native application;
generating, for each of the deeplinks, a respective quality score for the content referenced by the deeplink based on the respective relevance scores for the web resources and the respective similarity scores between the web resources and the content referenced by the deeplink;
selecting deeplinks referencing content having a respective quality score that satisfies a threshold quality score; and
providing, to a user device in response to the search query, the selected deeplinks with a plurality of web search results that each reference a corresponding web resource.

16. The computer-readable medium of claim 15, wherein generating, for each of the deeplinks, the respective quality score for the content referenced by the deeplink comprises:
computing, for each web resource, a respective product of the respective relevance score for the web resource and the respective similarity score between the web resource and the content referenced by the deeplink; and
summing each product to generate the respective quality score.

17. The computer-readable medium of claim 15, wherein each deeplink to a respective native application specifies a particular environment instance of the respective native application and, when selected at the user device, causes the respective native application to instantiate an instance of the respective native application in which content referenced in the deeplink is displayed.

18. The computer-readable medium of claim 15, wherein selecting deeplinks referencing content having respective quality scores that satisfy a threshold quality score comprises selecting a maximum number of deeplinks referencing content having quality scores that satisfy the threshold quality score.

19. The computer-readable medium of claim 15, wherein providing, to the user device, the plurality of deeplinks with the plurality of web search results comprises:
normalizing, for each deeplink, the respective quality score for the deeplink to the respective relevance scores for the web search results to generate a normalized relevance score for the deeplink;
ranking the web search results and deeplinks based on the relevance scores and the normalized relevance scores to generate a ranked list of web search results and deeplinks; and
providing the ranked list of web search results and deeplinks to the user device.

20. The computer-readable medium of claim 15, wherein the respective content referenced by the respective deeplink is not a web resource.
